(19) United States
(12) Patent Application Publication
(10) Pub. No.: US 2025/0035031 A1
(43) Pub. Date: Jan. 30, 2025

(54) INTERNAL COMBUSTION ENGINE COMPRISING PRECOMBUSTION CHAMBER

(71) Applicant: Liebherr Machines Bulle SA, Bulle (CH)

(72) Inventors: Olivier FRAGNIÈRE, Courtaman (CH); Roberto ANDREUTTI, Barbengo (CH); Bouzid SEBA, Riaz (CH); Fabio RICCA, Pully (CH)

(21) Appl. No.: 18/784,344

(22) Filed: Jul. 25, 2024

(30) Foreign Application Priority Data
Jul. 28, 2023 (CH) CH000820/2023

(51) Int. Cl. F02B 19/12; F02B 19/10

(52) U.S. Cl. CPC F02B 19/12; F02B 19/108

(57) ABSTRACT

The disclosure relates to an internal combustion engine, comprising a main combustion chamber in a cylinder of the internal combustion engine for combusting a fuel/air mixture, and an active precombustion chamber having an ignition device protruding therein for igniting a fuel/air mixture located in the precombustion chamber and having a precombustion chamber injector that supplies fuel to the precombustion chamber, wherein at least one precombustion chamber module is provided, configured as a component separate from and inserted into the cylinder head, and wherein the precombustion chamber module comprises a cavity that forms the precombustion chamber and has at least one transfer port for fluidically connecting the precombustion chamber and main combustion chamber.

### CROSS REFERENCE TO RELATED APPLICATION

The present application claims priority to Swiss Patent Application No. 000820/2023 filed on Jul. 28, 2023. The entire contents of the above-listed application are hereby incorporated by reference for all purposes.

### TECHNICAL FIELD

The disclosure relates to an internal combustion engine having a precombustion chamber, in particular a gas engine, comprising a main combustion chamber in a cylinder of the internal combustion engine for combusting a fuel/air mixture, and an active precombustion chamber.

### BACKGROUND

Combustion chamber units having an active precombustion chamber are already known in three different expansion stages. The first known and most widespread variant-referred to in the following as Design I-relates to an active precombustion chamber which merely performs the function of an ignition amplifier. A second variant corresponds to a combustion chamber unit, into the main combustion chamber of which fuel can be supplied merely via one single path extending via the active precombustion chamber. This variant is referred to hereinafter as Design II. In addition, combustion chamber units having an active precombustion chamber are known which selectively allow for fuel supply via the active precombustion chamber or alternatively via a second fuel path, for example by means of intake manifold injection. A corresponding embodiment, in which, due to the construction, the main injection for covering the fuel requirement necessary in the main combustion chamber can take place fully along the fuel path extending over the precombustion chamber only within a certain sub-region of the engine operating range, will be referred to in the following as Design IIIa. A corresponding embodiment, in which, despite the presence of a fuel path extending via the suction intake, the fuel path extending via the precombustion chamber is configured correspondingly, such that the internal combustion engine can take place exclusively via the precombustion chamber, within its entire speed/torque working range, is referred to in the following as Design IIIb.

### SUMMARY

Purely conceptually, i.e., from a schematic perspective, the implementation of this design appears to be very simple. In fact, the structural implementation for current engines, with their correspondingly high power density, is non-trivial. A correspondingly sufficient amount of energy emanating from the primary ignition unit must always spread in the precombustion chamber in a functional manner and thus reproducibly, specifically in order to ensure that the ignition process of the fuel/air mixture located inside the precombustion chamber takes place reliably and can be reproduced according to the demands. Furthermore, the precombustion chamber must be positioned in such a way that the ignition torches, overshooting into the main combustion chamber and still burning or already extinguished, but still having high thermal energy, due to the ignition process taking place inside the precombustion chamber, spread in the main combustion chamber a coordinated manner, i.e. in a synchronous manner, as it were. Only in this way does a uniform spread of the flame front occur within the main combustion chamber.

An engine design is already known from US2017/122184 A1 which provides for an active precombustion chamber. The combustion chamber unit provided with an active precombustion chamber is intended to be configured such that a supply of fuel, to be performed purposely, into the main combustion chamber can take place via the injector that introduces fuel into the precombustion chamber. However, the teaching of US2017/122184 A1 lacks a specific example as to how the integration of an active precombustion chamber of this kind into a usable internal combustion engine can actually be implemented.

On account of generally known requirements and particular advantages, internal combustion engines today have a high power density, specifically both with respect to the overall engine displacement volume and with regard to the power density based on the external dimensions of an internal combustion engine, and also with respect to the weight-related power density. Furthermore, on account of certain advantages, current internal combustion engines have not individual intake/exhaust valves but rather pairs thereof. Quasi eponymously, in the case of spark-ignited internal combustion engine it is necessary to introduce the ignition energy. In the case of a precombustion chamber engine, the external, i.e., primary, ignition energy must clearly be introduced into the precombustion chamber, as a result of which particular functional elements of the primary ignition device must be located inside the precombustion chamber or in the direct vicinity of the precombustion chamber.

Furthermore, an active precombustion chamber must have its own fuel supply path, which makes the integration yet more demanding. If the engine design provides that the main injection into the main combustion chamber should take place within the entire speed/torque operating range or at least a certain sub-region thereof, via the fuel path extending via the precombustion chamber, then the integration of a corresponding functional and reliable active precombustion chamber of this kind, due to the use of which the conceptually identifiable potential advantages actually come to bear in a usable product, is not limited to a simple component integration, but rather instead requires significant development effort. This relates to the arrangement and shaping of the geometry features of the precombustion chamber and the transfer ports, as well as the specific implementation of the respective supplies of the fuel and the primary ignition energy into the active precombustion chamber.

The availability of corresponding combustion chamber units allows for production of fully operational corresponding precombustion chamber engines, while maintaining the pre-existing short engine configuration. It is desirable for the relevant difference between a stock engine and a precombustion chamber engine derived therefrom is so small that there is complete identity of the interfaces (see below) between an existing internal combustion engine and an internal combustion engine according to the disclosure that is derived therefrom; at least provided that the latter has its basic configuration.

The term “interfaces” is intended to include the following, for example:
mechanical connections for fixing the internal combustion engine and those components and devices attached to the basic engine, relating to the fixing and torque transfer
connections to the internal combustion engine for inflowing and outflowing fluids, e.g., air, exhaust gas, fuel, lubricants and coolants, etc.

This achieves that
the developing work for an internal combustion engine according to the disclosure is as minimal as possible, provided a corresponding stock engine already exists or even if one such is already industrialized.
the integration of the resulting internal combustion engine into a superordinate system (e.g., a mobile work machine, a road vehicle or in a stationary system) requires the least possible effort, provided that a corresponding stock engine is already used in such a system, or such corresponding development progress exists for achieving this aim.

Ideally, achieving the above-mentioned aims should even allow for conversion of a stock engine that is already being used as intended.

In the case of a new engine construction to be performed, said engine should, based on a comparable internal combustion engine that meets current standards, have the same characteristic volume ratio between (i) the overall engine displacement and (ii) approximately the same or preferably smaller outside dimensions with respect to the engine block. According thereto, in particular the distance between in each case two combustion chambers that are located on the same cylinder bank and are in this case directly adjacent, must, according to current standards, be small, and equally the power density of each combustion chamber must be correspondingly high. Consequently, in each case merely comparatively small cross-sectional areas are available, over which the actually functional fuel supply path and the ignition path have to be moved towards the relevant precombustion chamber.

The present disclosure relates to the construction or modification of a combustion chamber unit which, in addition to the current standard functions, which can be achieved by such components corresponding to the prior art, comprises an active precombustion chamber. The integration of the active precombustion chamber should be implemented in such a way that it is possible to draw on a pre-existing structure of an internal combustion engine for the structure of a fully functional internal combustion engine, and the modifications necessary in this case are very largely limited to such measures that are directly due to the fact that it is an internal combustion engine which consists of such combustion chamber units that each comprise active precombustion chambers.

This object is achieved by an internal combustion engine having precombustion chamber ignition.

According to the disclosure, it is proposed that in an internal combustion engine of the type in question having precombustion chamber ignition, a precombustion chamber module is provided, which is configured as a component separate from the cylinder head. The precombustion chamber module comprises an integral cavity of this kind, which forms the precombustion chamber. Furthermore, the precombustion chamber module serves for functionally fixing the precombustion chamber injector and/or the ignition device (21) in the cylinder head, i.e., the precombustion chamber module constitutes a support for supportively receiving at least one precombustion chamber injector and/or one ignition device.

The precombustion chamber injector allows for the required amount of fuel to be supplied to the precombustion chamber. The ignition device protrudes into the cavity and provides the necessary energy for the ignition of the fuel/air mixture located in the cavity of the module. The ignition device is typically a spark plug.

The fuel can be supplied to the cavity, contained in the precombustion chamber module, by means of the precombustion chamber injector. The precombustion chamber module can be inserted into the cylinder head in such a way that at least a sub-region of the module wall protrudes into an associated main combustion chamber, or at least one transfer port provided in the wall of the module, leads into the associated main combustion chamber. The at least one transfer port ensures a fluidic connection between the cavity and the main combustion chamber.

The solution according to the disclosure has the advantage that a pre-existing configuration of an internal combustion engine can be used for integration of the active precombustion chamber, and the necessary modifications are very largely limited to such measures that are directly due to the fact that it is an internal combustion engine which consists of such combustion chamber units that each comprise active precombustion chambers. Due to the modular structure, i.e. the use of a precombustion chamber module, an existing internal combustion engine or even cylinder head can be equipped with the correct precombustion chamber module, depending on the intended design, i.e. depending on whether the precombustion chamber is intended to be used purely as an ignition amplifier (Design I), or also for direct injection of fuel into the main combustion chamber (Designs II, IIIa, IIIb). The disclosure thus makes it possible to use a structurally identical cylinder head, irrespective of whether the finished internal combustion engine is intended to be operated using Design I, II, IIIa or IIIb. Ideally, only the precombustion chamber fuel injectors, installed in the module, for the above mentioned designs, differ, while the cylinder head and the precombustion chamber module are independent of whether the internal combustion engine is intended to be operated according to Design I or II.

Precisely in the case of an operating mode according to Design II or also IIIa, IIIb, fuel injectors are required which can provide a sufficiently high injection volume per work cycle. In relation to the installation cross-section available for its installation, a fuel injector of this kind provides merely comparatively small dimensions in this respect, in particular in the case of such internal combustion engines having a high power density, such that the designs know from the prior art are not suitable for its arrangement. The volume per combustion chamber of the internal combustion engine can be between 2 liters and 5 liters.

For the precombustion chamber module according to the disclosure it is furthermore proposed that the longitudinal axis or the continuation of the longitudinal axis extends, at least in one of the components, out of the precombustion chamber injector or ignition device, inserted into the module, obliquely to the longitudinal axis of the main combustion chamber or the continuation thereof. In the following, for the sake of simplicity in all cases only longitudinal axes will be referred to, wherein this means either the longitudinal axis of the respective component, or the imagined continuation of the axis.

The fact that at least one of said components is supplied obliquely to the longitudinal axis of the main combustion chamber results in more installation space for the arrangement of the two components, precombustion chamber injector and ignition device, in the region above the main combustion chamber, within the cylinder head. Overall, this makes it possible to use fuel injectors for the precombustion chamber having a higher injection volume, i.e., that are capable of being able to provide a higher mass flow in this respect, in order to be able to meet the requirements placed on the presented Designs II, IIIa, IIIb.

For example, it was provided in the prior art to arrange the precombustion chamber injector and ignition device having virtually parallel longitudinal axes, which extend approximately in parallel with the longitudinal axis of the main combustion chamber. However, in practice the resulting side-by-side arrangement of the two components does not provide sufficient installation space to be able to use large-volume injectors, which, however, are necessarily required for the actual implementation on a usable internal combustion engine.

According to a preferred embodiment, the longitudinal axis of the obliquely arranged components, of precombustion chamber injector and/or ignition device, and the longitudinal axis of the main combustion chamber intersect. The two longitudinal axes thus form an angle which is in the range between 10° and 60°, preferably in the range between 20° and 50°, particularly preferably between 25° and 40°. The other of the components precombustion chamber injector and ignition device is mounted in such a way that the longitudinal axis thereof is directed in parallel with the longitudinal axis of the main combustion chamber, and ideally extends congruently therewith.

In the preferred embodiment, the longitudinal axis of the precombustion chamber injector is oriented in parallel with the longitudinal axis of the main combustion chamber or is positioned congruently therewith. It is therefore the ignition device that is supplied obliquely to the longitudinal axis of the main combustion chamber. As a result, optimum use can be made of the available installation space above the main combustion chamber in the cylinder head, for the installation of the precombustion chamber injector.

It is also preferable for the longitudinal axis of the cavity forming the precombustion chamber to be in parallel with or congruent or flush with the longitudinal axis of the ignition device or of a drilled hole receiving the ignition device, inside the precombustion chamber module. In particular, said cavity directly adjoins the ignition device. Accordingly, when the above-described advantageous embodiment having oblique supply of the ignition device is used, the longitudinal axis of the cavity forming the precombustion chamber also extends obliquely to the longitudinal axis of the main combustion chamber.

It is furthermore preferred for the longitudinal axis of the precombustion chamber injector and the longitudinal axis of the ignition device or the receiving drilled hole thereof to define a plane which is located in parallel with a plane spanned by the movement axes of the combustion chamber intake valve lifter and/or a plane spanned by the movement axes of the combustion chamber exhaust valve lifter. Particularly preferably, the plane spanned by the longitudinal axes of the precombustion chamber injector and of the ignition device is preferably located between the above-mentioned planes of the movement axes of the valve lifters.

The cylinder head and the precombustion chamber module can be configured such that fitting of the precombustion chamber module with the precombustion chamber injector and/or the ignition device is still possible before the module is installed in the cylinder head/Ideally, the precombustion chamber module can be inserted entirely into the cylinder head, as a structurally complete unit. This allows for a separate functional test of the precombustion chamber module and the installed components, still before they are installed in the cylinder head.

As already described above, the precombustion chamber module serves as a support for the precombustion chamber injector and the ignition device. However, this does not exclude the possibility of these two components likewise being fixed to the cylinder head. For the supporting receiving of the precombustion chamber injector and the ignition device, preferably receiving drilled holes are provided in the precombustion chamber module, into which holes said components can be inserted.

In one embodiment of the disclosure, the nozzle of the precombustion chamber injector does not protrude directly into the volume of the cavity forming the precombustion chamber, but rather, instead, a connecting channel is integrated within the module material, which channel fluidically connects the nozzle of the precombustion chamber injector to said cavity. In the simplest case, the connecting channel can be configured cylindrically over the entire length. However, an embodiment having a profile shape that changes in the longitudinal direction is also conceivable. Ideally, the connecting channel comprises at least one conical portion, in particular the channel diameter reduces, in this respect, in the direction of the cavity. Such an embodiment of the connecting channel can effectively prevent or minimize the occurrence of the undesired effect of backfiring from the precombustion chamber in the direction of the precombustion chamber injector.

It is also desirable for the channel shape to be configured or to be provided with suitable guide elements such that turbulence of the fuel injected into the cavity is actively produced. Turbulence in the intake region of the precombustion chamber improves the mixing of the injected fuel with the air mixture contained in the precombustion chamber.

The connecting channel can have a straight course, but a course that is curved or angled in portions is also conceivable, wherein the trajectory over which the curvature extends can preferably be located in one plane. This can also promote improved homogencity of the fuel/air mixture within the precombustion chamber. A channel course which has a helical shape at least within one portion is also conceivable. The helical or coil-like channel guidance produces an eddy formation within the cavity for the fuel entering the cavity, which eddy formation can be very advantageous for the formation of the fuel/air mixture within the precombustion chamber. A quarter or a half of a complete coil shape may be sufficient for this. A correspondingly good mixture formation is in particular extremely desirable if the operating strategy of the engine operation provides for such a combustion air ratio within the precombustion chamber, at a respective ignition time, that is relatively close to the ignitability limit, i.e. at a high fuel excess or a high air excess. In particular one of these above-mentioned engine operating strategies, and thus a corresponding configuration of the connecting channel, is extremely advantageous for such an internal combustion engine which is operated in a balanced ratio with respect to its main combustion chamber having a very high air excess, whereas there is a very high fuel excess in the precombustion chamber thereof, at the ignition time. For an internal combustion engine that is operated accordingly, on account of the precombustion chamber ignition in relation to the precombustion chamber loading a comparatively large amount of already significantly heated fuel is injected into the main combustion chamber via the transfer ports, in a respectively corresponding time corridor, which fuel burns reliably on account of the high air excess in said main combustion chamber. This has the significant advantage that a substantially higher portion of the thermal energy of the fuel originating from the precombustion chamber loading is released first in the main combustion chamber, in order to achieve always reliable triggering of the combustion of the lean fuel/air mixture contained therein, i.e. the original fuel/air loading within the main combustion chamber. The advantages of what is known as lean engine operation, provided that the fuel/air mixture formation is correspondingly reliable and in the process is maintained in a continuously compliant manner, are known to a person skilled in the art.

The precombustion chamber module can be manufactured in one piece. According to a preferred embodiment, the precombustion chamber module can, however, also be manufactured in multiple parts. For example, specific sub-regions of the precombustion chamber module are subject to different demands with respect to dimensional compliance and surface quality. Against this background, it is expedient to manufacture those sub-region that are subject to higher demands with respect to dimensional compliance and surface quality as a first separate component. Said first components are to be produced using a suitable manufacturing method, which satisfies these demands. Other sub-regions of the module for which a higher degree of tolerance for dimensional compliance and surface quality is acceptable can instead be manufactured separately as at least one second component. In other words, sub-regions having similar demands with respect to dimensional compliance and surface quality should as far as possible be concentrated in a common single component of the module.

A 3D printing method or an additive manufacturing method is proposed as a suitable manufacturing method for the at least one first component having higher demands with respect to dimensional compliance and surface quality. The at least one second component having greater manufacturing tolerance can be produced for example by means of conventional subtractive methods.

A first component, which is subject to higher precision demands with respect to the dimensional compliance and surface quality, comprises for example those sub-regions in which the cavity forming the precombustion chamber, including the transfer port(s), is contained. Furthermore, it is also advantageous for the first component to comprise the supply channel from the precombustion chamber injector to the cavity. The second component having higher manufacturing tolerance contains the sub-regions which have a purely supporting function, such as that of receiving the precombustion chamber injector and/or the ignition device, and/or any fastening means for fixing the precombustion chamber module in the cylinder head.

It is also advantageous if those regions of the precombustion chamber module which are subject to comparatively high wear, such as the cavity and the transfer ports, are integrated fully in a common component of the multipart precombustion chamber module. This makes it possible to be able to replace such wearing parts in a targeted manner, and to avoid a complete replacement of the precombustion chamber module.

A particularly advantageous embodiment of the disclosure provides that the ignition device is accessible and can be dismantled or mounted from outside the engine block, or the cylinder head and/or cylinder head cover. Since the ignition device/spark plug is a wearing part, a simple exchange without an existing need to dismantle the cylinder head cover is desirable. Accessibility is particularly good if the ignition device is the component having its longitudinal axis oriented obliquely to the longitudinal axis of the main combustion chamber. As a result, the end of the ignition device emerging from the cylinder head is not located in the vicinity of the valve lifter. The internal combustion engine may possibly comprise a pair of intake and exhaust valves per combustion chamber. A large region above a fully equipped cylinder head is occupied by such components belonging to the valve drive. The oblique guidance of the ignition device out of the cylinder head, in particular in the direction of the air intake, thus makes the exposed end of the ignition device freely accessible.

As has already been mentioned above, the longitudinal axis of the cavity forming the precombustion chamber can intersect with the longitudinal axis of the main combustion chamber. Since a symmetrical supply of the fuel/air mixture or of the ignition torches out of the precombustion chamber into the main combustion chamber is desirable, particular importance should be given to the arrangement of the transfer ports. Preferably, at least two or a plurality of transfer ports are of different port lengths, in order that, in the case of a fuel injection via the precombustion chamber into the main combustion chamber, a symmetrical spray pattern results in the mouth region within the main combustion chamber, in particular due to an arrangement of the outlet opening, in the corresponding wall region of the precombustion chamber module, that is symmetrical from the perspective of the main combustion chamber.

In particular, it is expedient if the outlet points of the transfer ports are arranged on a common annular group on the dome region of the precombustion chamber module protruding into the main combustion chamber. In particular, these are arranged in a rotationally symmetrical manner with respect to an axis extending with respect to the longitudinal axis of the main combustion chamber. This promotes the formation of a symmetrical spray pattern of the mixture entering the main combustion chamber, although the longitudinal axis of the cavity forming the precombustion chamber does not extend in parallel with, let alone congruently with, the longitudinal axis of the main combustion chamber. Inside the cavity forming the precombustion chamber, the arrangement of the opening inlets of the transfer ports into the main combustion chamber is preferably not rotationally symmetrical with respect to the longitudinal axis of the precombustion chamber.

It can also be provided that the walls of the precombustion chamber module are shaped in their dome region, i.e., in the vicinity of the transfer ports, in such a way that such transfer ports of which the outlet points are located on a common annular group are all of the same port length.

Ideally, at least some of the transfer ports penetrate the precombustion chamber wall into the main combustion chamber not perpendicularly (i.e. with respect to the respective local tangential plane) but rather obliquely, i.e. the ports penetrate the precombustion chamber wall in a certain oblique position based on the dome periphery, as a result of which corresponding turbulence occurs, both in the case of the fuel transport, extending via the transfer ports, into the main combustion chamber, and likewise in the opposite direction for the transport of fuel/air mixture into the precombustion chamber, in order that a better fuel/air mixture formation results, in the main combustion chamber or in the precombustion chamber, during the respectively corresponding operating phases.

A seat ring, which is preferably configured as a flange ring, which surrounds the precombustion chamber module in the region of the cavity, can be provided between the precombustion chamber module, in particular in the region of the at least one transfer port, and the associated contact surface on the cylinder head, in particular in the region of the flame plate.

Furthermore, it is expedient for the cavity forming the precombustion chamber not to have a rotationally symmetrical geometry, but rather instead to have one or more volume-enlarging partial widenings. The widening can be bead-like. Corresponding partial widenings are preferably present in or around the mouth region of the precombustion chamber injector or of the relevant connecting channel. With the aid of the partial widening, better mixing of the entering fuel with the air already located in the cavity can be achieved, which in each case comes into play advantageously within those operating phases in which the fuel loading of the precombustion chamber takes place which is used for the formation of the ignition torches. The partial widening is preferably configured such that there is precisely one imaginary plane positioned in this way, by which the precombustion chamber or the cavity can be notionally divided into two regions, which each have the same geometry.

The precombustion chamber injector is preferably introduced into a recess of the precombustion chamber module, and fixed to the module by means of a holding clamp. The holding clamp is screwed to the top of the precombustion chamber module.

The ignition device, in particular spark plug, can be received in a suitable drilled hole of the precombustion chamber module and be secured with the aid of a sleeve that surrounds the spark plug. In this case, the sleeve can be fastened both to the precombustion chamber module and to the cylinder head and/or cylinder head cover. The spark plug can, together with the sleeve, protrude out of the cylinder head cover, such that it is possible to exchange the spark plug without dismantling the cylinder head cover.

On account of the occurring temperatures in the region of the precombustion chamber, cooling of the precombustion chamber module is necessary and expedient. Possible cooling channels extending in the cylinder head are preferably adapted to the structure of the precombustion chamber module and flow around the inserted module. Ideally, coolant flows directly around the wall of precombustion chamber module. The wall of the precombustion chamber module can be provided with one or more ribs, for the purpose of enlarging the surface and increasing the achievable cooling effect.

Furthermore, turbulence of the coolant flowing past can be purposely produced in the region around the cavity by a specific wall contour, as a result of which turbulence the cooling effect can be further optimized.

The precombustion chamber module can preferably be provided with at least one sensor chamber for receiving a sensor. A sensor chamber of this kind preferably protrudes into the precombustion chamber or is in the vicinity in the region of the cavity wall, in order to be able to acquire characteristic measured variables for the precombustion chamber. For example, a temperature and/or pressure measurement or the measurement of the air/fuel ratio in the precombustion chamber, i.e., the lambda value, is conceivable.

The described internal combustion engine is preferably suitable for being operated in an operating mode; according to this, the active precombustion chamber is used exclusively as an ignition amplifier for the main combustion chamber functionally assigned thereto. Alternatively or in addition, the internal combustion engine can preferably also be operated such that there is a direct injection of fuel into the main combustion chamber via the active precombustion chamber, wherein for example the amount of fuel required in full load operation can be supplied into the main combustion chamber via the precombustion chamber, or at least the amount required for partial load operation. It is also conceivable for the internal combustion engine to comprise at least one fuel supply path into the main combustion chamber that is an alternative to the precombustion chamber, for example intake manifold injection. In this case, the internal combustion engine may be suitable for supplying the fuel into the main combustion chamber selectively via the precombustion chamber and/or the alternative fuel path, for example depending on the current engine load.

The internal combustion engine may be a hydrogen engine. The internal combustion engine can furthermore additionally comprise intake manifold injection, which, in one of the possible embodiments, is the only fuel supply path for the main combustion chamber, while the precombustion chamber functions merely as an ignition amplifier, or which, in another possible embodiment, serves as one of the possible fuel supply paths into the main combustion chamber. It is preferable for the relevant fuel output out of the injector present for the intake manifold injection takes place, on account of its arrangement and configuration, in the portion of the suction duct which is already incorporated in the cylinder head. The injector for the intake manifold injection can then preferably be fastened indirectly or preferably directly on the cylinder head.

In an optional embodiment, a valve may be located between the cavity of the precombustion chamber module that forms the precombustion chamber, and the main combustion chamber. Ideally, however, the valve integration or valve construction takes place such that at least one open fluid connection between the precombustion chamber and the main combustion chamber remains, irrespective of the position of the valve closure element. In another position of the valve closure element, there is then at least one further fluid connection between the cavity forming the precombustion chamber and the main combustion chamber.

### BRIEF DESCRIPTION OF THE FIGURES

Further advantages and properties of the disclosure will be explained in greater detail in the following, with reference to an embodiment shown in the figures, in which:

FIG. 1: is a cross-section through the cylinder head of a first embodiment of the internal combustion engine according to the disclosure, having an inserted precombustion chamber module,

FIG. 2: is a detailed view of the cylinder head according to FIG. 1 in the region of the cavity that forms the precombustion chamber,

FIG. 3a, 3b: are perspective views of the non-equipped cylinder head according to the first embodiment,

FIG. 4: is a plan view of the non-equipped cylinder head according to the first embodiment,

FIG. 5: is a perspective view of the fully equipped cylinder head according to the first embodiment,

FIG. 6: is an exploded view of the cylinder head together with the precombustion chamber module, according to the first embodiment,

FIG. 7a, 7b: show different variants of the precombustion chamber module,

FIG. 7c: is a sectional view of the precombustion chamber module,

FIGS. 8a-8c: are detailed views of the precombustion chamber module,

FIG. 9: is a schematic view of the flame plate of the cylinder head, viewed from a perspective from the combustion chamber,

FIG. 10a, 10b: shows a further alternative embodiment of the precombustion chamber module,

FIG. 11a, 11b: are sectional views through the cylinder head according to the disclosure of the internal combustion engine according to the first embodiment, with two different variants of a mounted cylinder head cover, and

FIG. 12: shows a further alternative embodiment of the precombustion chamber module.

### DETAILED DESCRIPTION

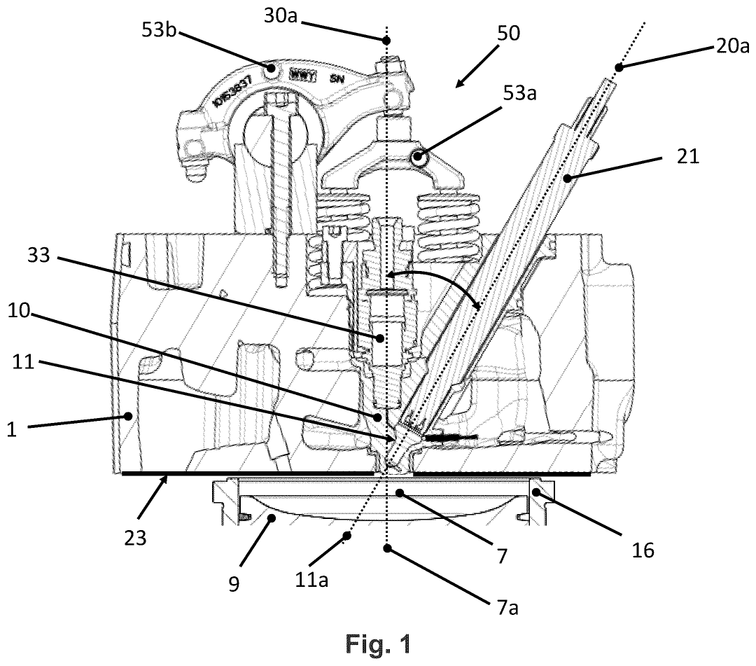

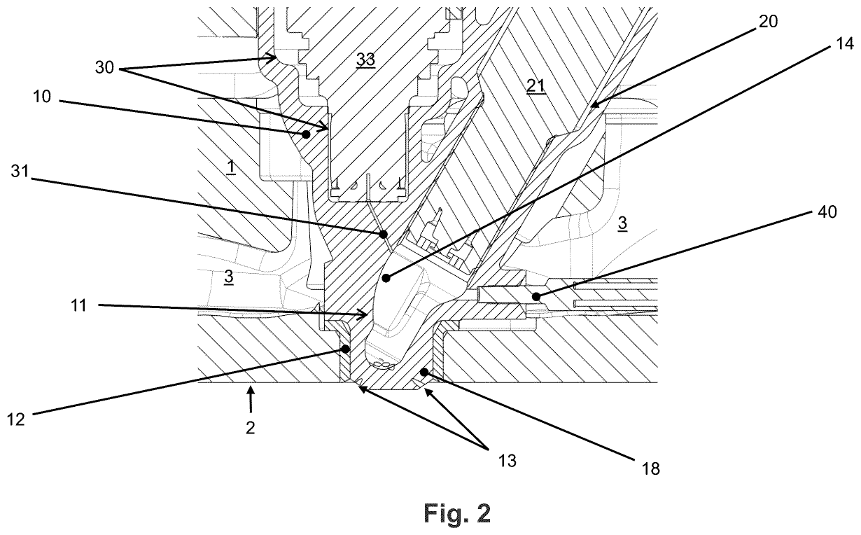

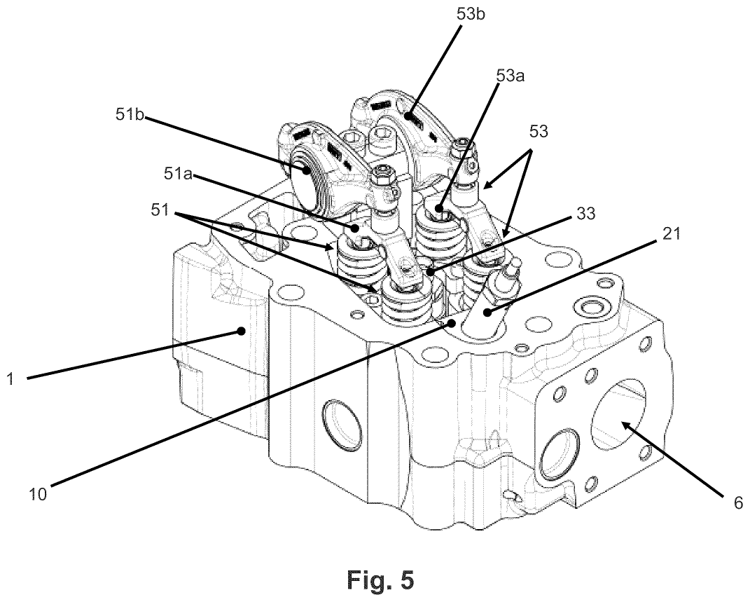

FIG. 1 is a cross-section through the cylinder head 1 of an internal combustion engine according to the disclosure, which is preferably configured as a gas engine, in particular as a hydrogen engine. FIG. 2-5 are alternative perspective or detailed views of this embodiment. Reference sign 2 denotes the region of the flame plate 2 of the cylinder head 1. On the top of the cylinder head 1, the valve drives 50 for the intake and exhaust valves are installed above the respective main combustion chambers. In the case of the internal combustion engine shown here, there is a pair of intake and exhaust valves 53, 51 per combustion chamber, which can each be actuated via a common valve bridge 51a, 53a and the common rocker lever 51b, 53b (see FIG. 5, 6). Below the valve drive 50, the precombustion chamber module 10 is inserted into a recess 4 of the cylinder head 1 provided for it.

The precombustion chamber module 10 serves as a support for a spark plug 21, and a precombustion chamber injector 33. For this purpose, the spark plug 21 is inserted into a corresponding receiving drilled hole 20 of the precombustion chamber module 10, the stepped receiving drilled hole 30 serves for insertion of the precombustion chamber injector 33. The longitudinal axis 30a of the receiving drilled hole 30 or of the inserted precombustion chamber injector 33 extends flush or congruently with the longitudinal or rotational axis of the main combustion chamber 7 located therebelow. Relating to the piston 9 and the liner 16, the selected longitudinal section shows only the vicinity of the combustion bowl. The cylinder head seal is denoted by reference sign 23. The longitudinal axis 20a of the receiving drilled hole 20 or the inserted spark plug 21 extends obliquely to the axis 30a or to the combustion chamber axis 7a. The cavity forming the combustion chamber volume of the precombustion chamber is denoted by reference sign 11. It can be seen that the longitudinal axis 11a of the cavity 11, i.e. the precombustion chamber, is located on the longitudinal axis 20a of the ignition device, and thus is also oriented obliquely to the longitudinal axis 7a of the main combustion chamber 7 and the longitudinal axis 30a of the precombustion chamber injector 33.

As a result of this measure, the available installation space under the valve drive 50 can be utilized almost entirely for the installation of a precombustion chamber injector 33, as a result of which this can be dimensioned to be significantly larger, and the maximum amount of fuel that can be supplied by means of the precombustion chamber injector 33 per cycle—or within a time corridor available therein—increases significantly. The proposed construction thus allows for an engine operating design according to the variants I, II, IIIa and IIIb mentioned at the outset.

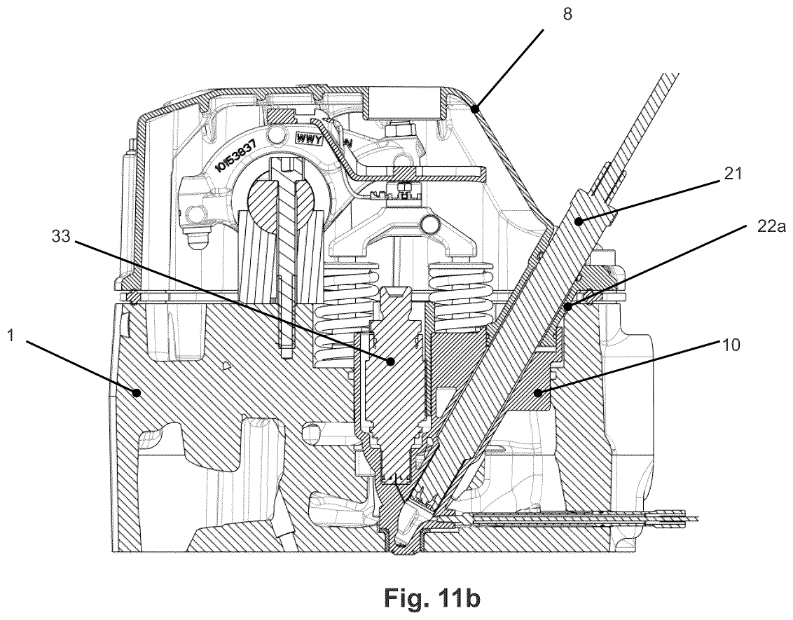

A further advantage of this construction is that, due to the oblique positioning, the end of the spark plug 21 does not emerge from the cylinder head in the region of the valve drive 50, but rather moves relative thereto in the direction of the air intake. Thus, the exposed end of the spark plug 21 is freely accessible. Ideally, the tilt angle of the longitudinal axis 20a is selected in such a way that the spark plug 21 does not protrude out of the cylinder head 1 under the cylinder head cover 8 that is placed on, but rather also protrudes in a manner offset laterally in the direction of the air intake (see FIG. 11a, 11b), such that the spark plug 21 can be exchanged accessibly and conveniently, without dismantling the cylinder head cover 8 or other components of the cylinder head 1. For stabilizing and fixing the spark plug 21, for this purpose a guide sleeve 22 that lengthens the receiving drilled hole 20 is inserted into said hole, which sleeve is fixed to the precombustion chamber module 10 on one side and to the edge of the cylinder head cover 8 on the other side (see FIG. 11a). Alternatively, the guide sleeve 22a could also be formed entirely by the cylinder head cover 8 (FIG. 11b), wherein in this case manufacture of the cylinder head cover 8 by means of 3D printing or another additive production method is expedient.

An enlarged detailed view of the precombustion chamber module 10, in particular of the region around the cavity 11, is shown in FIG. 2. This embodiment of the precombustion chamber module 10, shown enlarged here, shows a cavity 11, forming the precombustion chamber, which is not rotationally symmetrical, but rather instead has a geometry that varies over its periphery. In particular, in this case, a partial widening 14 of the cavity 11, enlarging the diameter, is provided in the region under the fuel supply opening of the channel 31, which is associated, as a result, with a general widening of the corresponding local outside dimensions. This widening makes it possible for turbulence of the entering fuel to be created in a targeted manner, and thus improved mixing with the air mixture contained inside the precombustion chamber to be achieved. The precombustion chamber injector 33 is fluidically connected to the cavity 11, via the connecting channel 31 integrated into the module, for the purpose of the supply of fuel into the precombustion chamber. In the embodiment shown here, the supply channel 31 has a straight course, wherein in the simplest case this can be configured to be cylindrical. However, a channel configuration which is conical at least in portions is preferable, wherein the channel diameter preferably reduces in the direction of the cavity 11. This measure makes it possible for undesired backfiring from the precombustion chamber in the direction of the precombustion chamber injector 33 to be reduced or prevented.

The lower dome 18 of the precombustion chamber module 10 protrudes out of the flame plate 2 of the cylinder head 1 and ends in the main combustion chamber 7. The dome 18 comprises a plurality of transfer ports 13, which form the necessary fluidic connection between the precombustion chamber and the main combustion chamber 7. Said transfer ports 13 allow both for the through-flow of fuel from the precombustion chamber into the main combustion chamber 7, quasi a direct injection, and also overshooting of the ignition torches from the precombustion chamber into the main combustion chamber 7. These transfer ports 13 also serve to supply air into the precombustion chamber. A flange ring 12 extends around the outer periphery of the dome 18 of the precombustion chamber module 10, in order to seal the main combustion chamber 7 in the inlet region of the dome 18 of the precombustion chamber module 10.

Furthermore, sub-portions of the cooling channels 3 extending in the cylinder head 1 can be seen in the cross-sectional view. The course of the cooling channels 3 was adjusted such that the circulating cooling medium can flow directly around the inserted precombustion chamber module 10, in particular in the wall region that directly surrounds the cavity 11 that corresponds to the precombustion chamber.

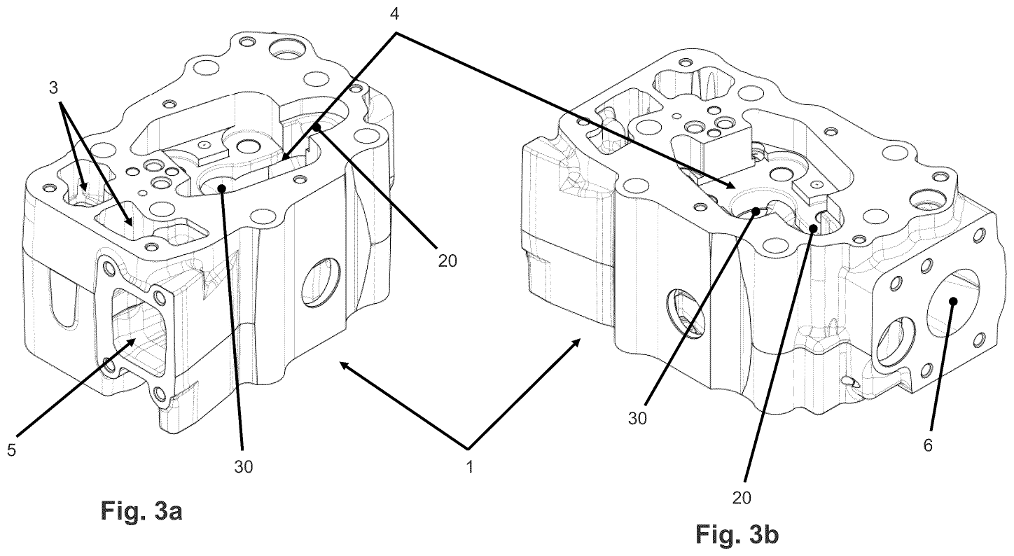

FIG. 3a, 3b are perspective views of the non-equipped cylinder head 1 comprising the corresponding recess 4 for the insertion of the precombustion chamber module 10. The recess 4 also serves for installation of the valve lifter for the intake and exhaust valves 53, 51. It can be seen in this illustration that the receiving drilled hole 20 for the spark plug 21 protrudes obliquely into the cylinder head 1, in the vicinity of the air intake 6. The opening of the exhaust gas outlet 5 is located on the side of the cylinder head 1 opposite the air intake 6.

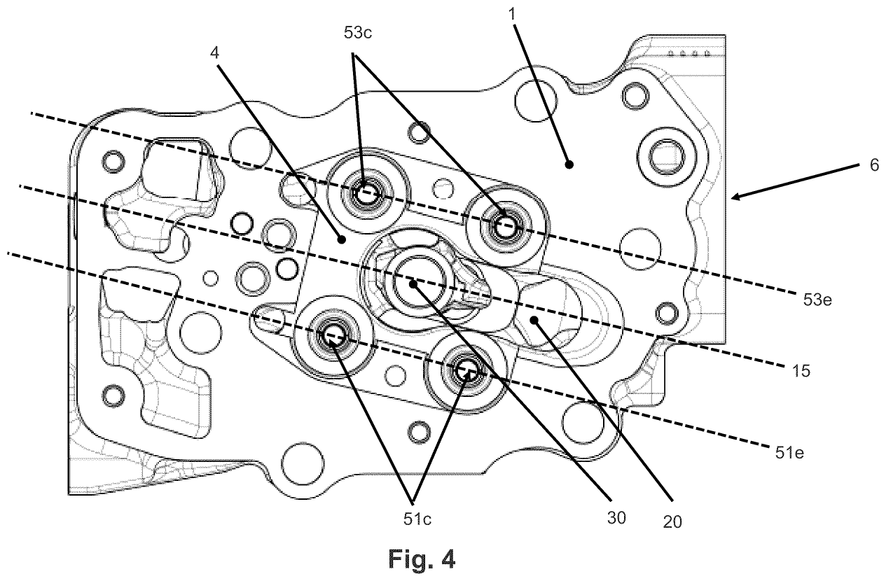

FIG. 4 is a plan view of the cylinder head 1 and is intended to illustrate the position of the precombustion chamber module 10 relative to the valve drive 50. The recess 4 comprising the drilled holes 20, 30 and the drilled holes 53c for receiving the valve lifters of the intake valve 53, and the corresponding drilled holes 51c relating to the exhaust valves 51 are visible. The dashed line 53e corresponds to the plane spanned by the respective imaginary center axis of the two intake valves 53 or the corresponding valve lifters 55a, the dashed plane 51e represents the plane spanned by the respective imaginary center axis of the two exhaust valves 51 or the corresponding valve lifters 55b. The spanned plane 15 corresponds to the plane spanned by the longitudinal axes 30a, 20a of the precombustion chamber injector 33 and of the spark plug 21. It can be seen that the latter plane 15 is located in parallel between the two planes 51c, 53c, in particular centrally between the two planes 51e, 53c. FIG. 5 shows the fully equipped cylinder head having the valve drive 50 and the inserted precombustion chamber module 10.

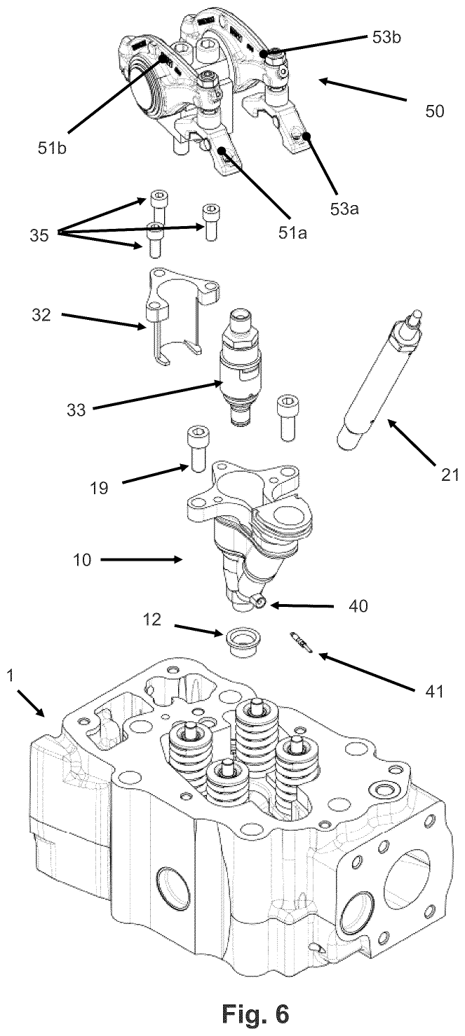

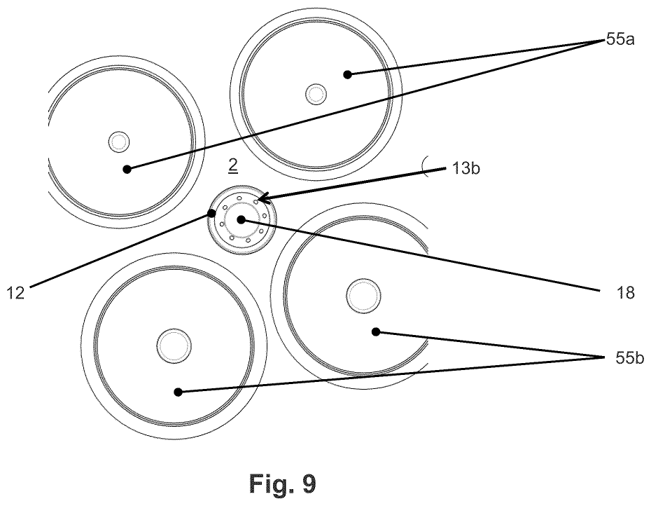

FIG. 6 is an exploded view of a number of components, in focus here, in the vicinity of the cylinder head 1. The fixing of the precombustion chamber module 10 to the cylinder head 1 is achieved by means of the two screws 19, which are guided through the drilled holes 34 (FIG. 8a) of the upper collar of the precombustion chamber module 10. The precombustion chamber injector 33 can be fixed to the precombustion chamber module 10 using a holding clamp 32 which can also be inserted into the drilled hole 30 for receiving the precombustion chamber injector 33. The holding clamp 32 is fixed to the precombustion chamber module 10 by means of the three screws 35, wherein for this purpose corresponding drilled holes 36 are also provided on the collar (FIG. 8a). Here, reference sign 40 shows a sensor access, in order to be able to install a sensor 41 in the region of the cavity 11, inside the precombustion chamber module 10. The sensor 41 can for example be a sensor for acquiring pressure values and/or temperature values and/or the lambda value within the precombustion chamber.

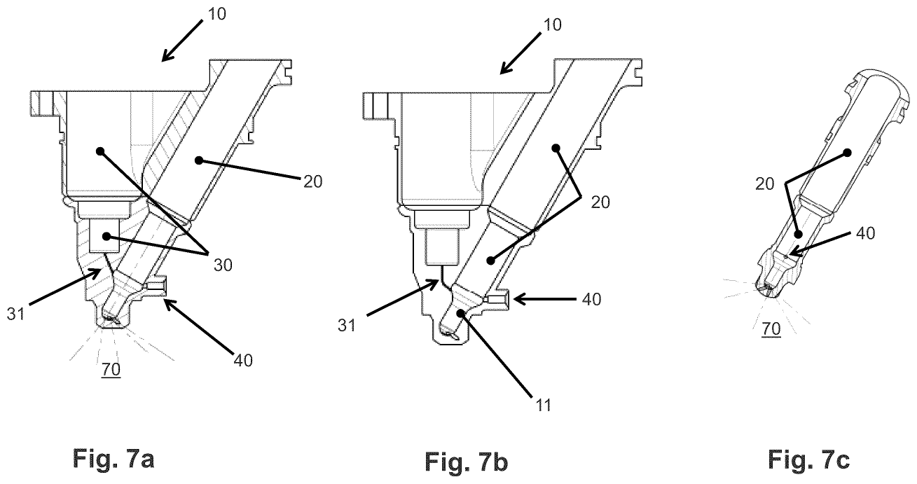

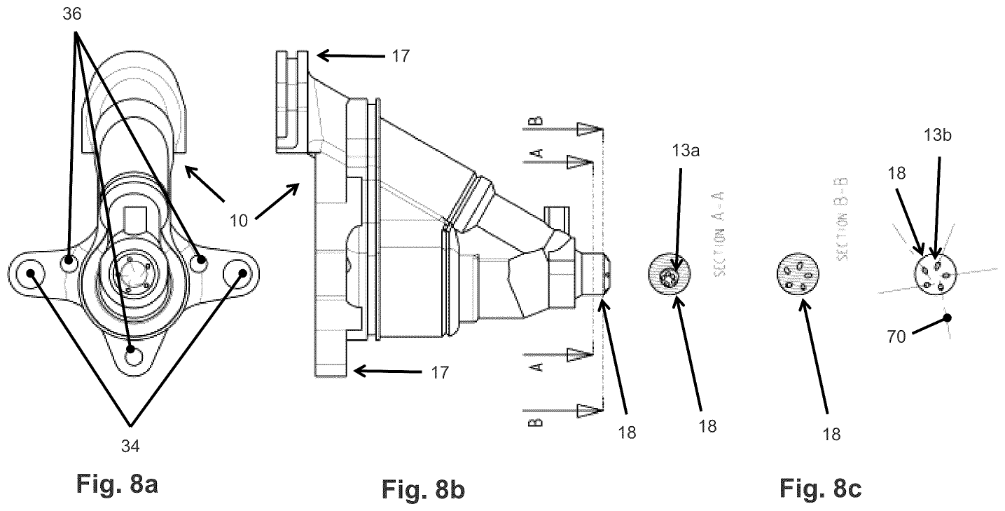

FIG. 7a, 7b show different embodiments of the precombustion chamber module 10, which differ from one another with respect to the channel guidance of the connecting channel 31. In the left-hand view of FIG. 7a, the connecting channel 31 is straight. In the embodiment of FIG. 7b, the connecting channel 31 instead has an angled or curved channel course, wherein the configuration is such that the entire channel course is exposed by a corresponding selected planar cut. Alternatively to those embodiments shown, the connecting channel can have a helical course. During operation, the helical or coil-shaped channel guidance additionally forces turbulence of the fuel introduced into the cavity 11 forming the precombustion chamber, as a result of which the mixing there with the amount of air present therein can be promoted.

FIG. 7c is a sectional view of the precombustion chamber module 10 along the longitudinal axis 20a, wherein the precombustion chamber module 10 has been rotated about 90° in the clockwise direction, with respect to the orientation present in FIG. 7a, 7b.

The line illustrations 70 indicate the spray pattern of the fuel supplied into the main combustion chamber 7 via the precombustion chamber. Within the main combustion chamber 7, the spray pattern 70 is intended to be optimally symmetrical, which, on account of the orientation of the cavity 11, forming the precombustion chamber, in a manner inclined relative to the main combustion chamber 7 requires in each case an orientation of each of the transfer ports 13 that is individually matched thereto.

This particular orientation of the transfer ports 13 is shown in the sectional views of FIG. 8c. Here, the left-hand illustration has a profile cross-section through the dome 18 in the lower region of the cavity 11. Therefore, the port openings 13a, located close together, inside the cavity 11 are therefore visible. The central illustration is a profile section close to the lower edge of the dome 18, and the right-hand illustration is a view of the underside of the dome 18 which, with respect to an operation-ready installation on a combustion chamber unit or an operation-ready internal combustion engine, is located inside the main combustion chamber 7. It can be seen here that the outlet openings 13b of the transfer ports 13 are arranged on an annular group of the dome 18. This makes it possible for the length of the individual transfer ports 13 to be selected differently, as a result of which the oblique position of the cavity 11 forming the precombustion chamber is compensated, in order to be able to achieve the above-mentioned symmetrical spray pattern inside the main combustion chamber 7.

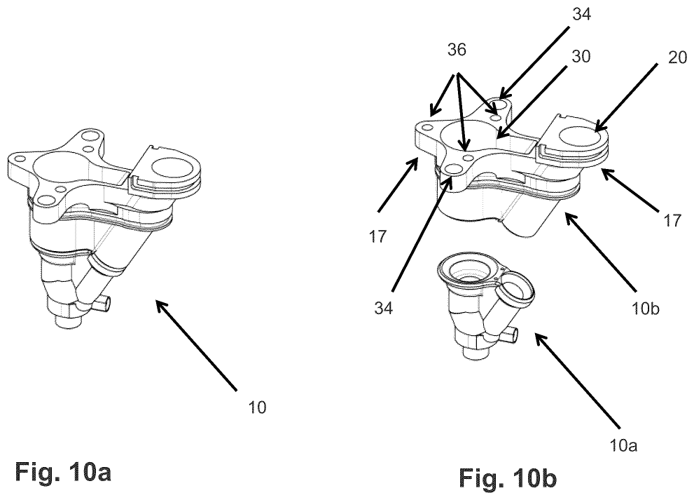

FIG. 9 is a view of the underside of the dome 18, from a perspective inside the main combustion chamber 7. The undersides of the valve lifters 55a, 55b of the intake and exhaust valves 51, 53 are visible. From this perspective, the symmetrical and uniformly distributed arrangement of the openings 13b of the transfer ports 13 on a common annular group is visible, which is decisive for a symmetrical spray pattern 70.

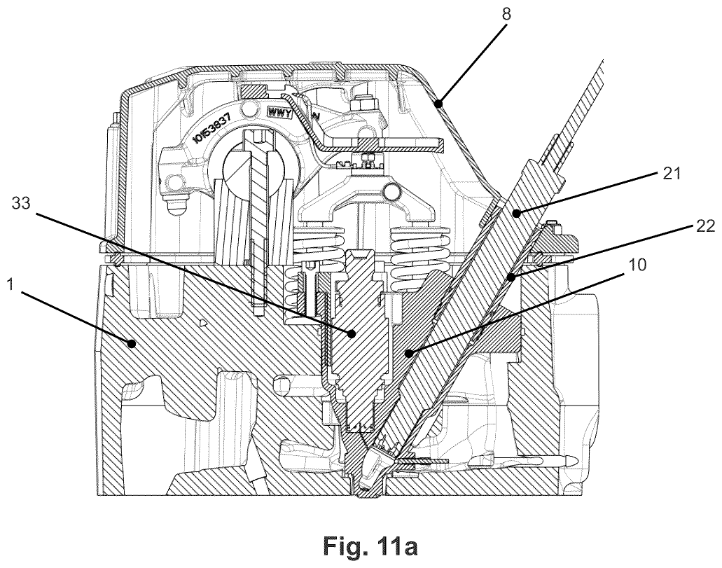

FIG. 10a, 10b explicitly show a multipart embodiment of the precombustion chamber module 10. In this embodiment, the precombustion chamber module 10 is configured at least in two parts and consists of a first component 10a, in which the cavity 11 forming the precombustion chamber, the connecting channel 31, and the transfer ports 13 are contained. The upper part 10b comprises merely a majority, in terms of volume, of the recesses 20, 30 for receiving the spark plug 21 and the precombustion chamber injector 33, the contact surfaces 17 for striking against the cylinder head 1, and the drilled holes 34, 36. Since in particular the first component 10a is subject to significantly higher demands on the dimension specifications and the surface quality, the first component 10a is produced according to the disclosure by 3D printing or by means of another additive method, whereas preferably a more cost-effective method is used for manufacturing the further component 10b. It is of course also conceivable that the precombustion chamber module 10 may consist of and be made up from more than two individual parts.

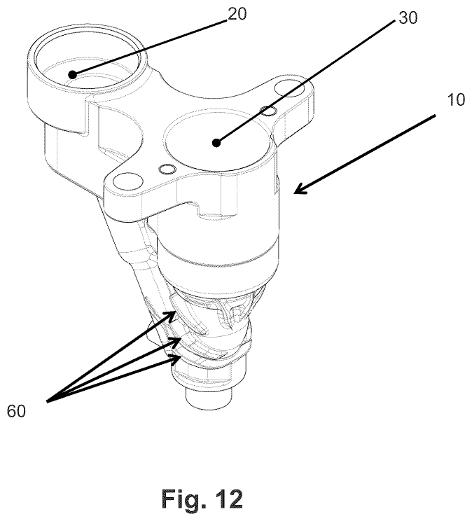

FIG. 12 is a perspective view of the precombustion chamber module 10 which is provided with ribs 60 in the region of the outer surfaces around which a cooling medium flows, in order to thereby achieve greater cooling of the cavity 11 forming the precombustion chamber. The rib-shaped configuration is preferably selected such that it results not only simply in a general surface enlargement, but rather furthermore turbulence, oriented in this way, of the cooling medium flowing around, can be produced, which turbulence locally promotes the dissipation of heat particularly effectively where the cooling is associated with particularly high added value.

As has already been set out repeatedly, the disclosure, explained in detail above, has the advantage that, based on an engine basis and by a comparatively minor modification of the structure, a range of internal combustion engines according to different designs is available. According to Design I, the active precombustion chamber integrated by means of the precombustion chamber module 10 can perform merely the function of an ignition amplifier. Integration of the precombustion chamber module 10 available for this, and the type-appropriate equipping thereof makes it possible for the internal combustion engine to be operated according to Design II. The main combustion chamber 7 of an internal combustion engine equipped in this way can be supplied with fuel merely via the active precombustion chamber, because no further fuel path is present. If an alternative fuel path to this exists, for example via intake manifold injection, then the internal combustion engine can selectively provide a fuel supply via the active precombustion chamber or alternatively via the second fuel path, for example by means of intake manifold injection. A corresponding embodiment, in which, due to the construction, the main injection for covering the fuel requirement necessary in the main combustion chamber can take place fully along the fuel path extending over the precombustion chamber only within a limited portion of the engine operating range, is possible (Design IIIa). An embodiment is also possible in which, despite the existence of an alternative fuel path (for example via intake manifold injection), the fuel path extending via the precombustion chamber is configured such that the internal combustion engine can obtain a fuel supply exclusively via the precombustion chamber, within its entire speed/torque working range (Design IIIb).

In the case of the last variant, i.e. a combustion chamber unit according to the Design IIIb, in corresponding engine operating situations it is provided, in accordance with the embodiment and as intended, that the active precombustion chamber optionally performs the function of an ignition amplifier, and/or optionally secondary injections can take place via the active precombustion chamber, while the fuel supply that serves for building up the actual engine torque takes place exclusively via the inlet manifold intake, or a first portion of the correspondingly required amount of fuel is supplied via the inlet manifold intake, and a remaining portion via the precombustion chamber. A corresponding operation according to the two last-mentioned variants can also be carried out for a combustion chamber unit configured according to Design IIIa, if the current engine operating point is covered with a correspondingly small supply of fuel which, in terms of amount, can be covered by using only the fuel path extending via the precombustion chamber.

Assuming that the corresponding dimensions are identical, for example the piston bore and the distance between two adjacent piston bores in each case, etc., the disclosure makes it possible to equip internal combustion engines, which each belong to different design series, with cross-series identically configured cylinder heads, and specifically irrespective of whether the finished internal combustion engine is intended to correspond to Design I, II, IIIa or IIIB.

The disclosure furthermore has the advantage that, proceeding from a basic engine which is not equipped with an (active) precombustion chamber, the necessary modification is limited to the replacement of the cylinder head together with installation of the precombustion chamber module, while the short engine (engine block, crank drive, valve drive) can be retained. All other modifications which are necessarily to be performed are limited to newly added components; in particular the active precombustion chamber and its retaining device, as well as the substitution of the fuel supply path or addition of a second fuel supply path. Further changes to the peripheral equipment may be expedient, in order to be able to better utilize the advantageous nature of a corresponding internal combustion engine according to the disclosure; for example a change to the air gap or an optional further modification of the fuel path, for example in order to allow for a fuel supply under a higher pressure level.

List of Reference Signs

| | |
|---|---|
| Cylinder head | 1 |
| Flame plate | 2 |
| Cooling channel | 3 |
| Receptacle for precombustion chamber module | 4 |
| Air outlet | 5 |
| Air intake | 6 |
| Main combustion chamber | 7 |
| Main combustion chamber longitudinal axis | 11a |
| Cylinder head cover | 8 |
| Piston | 9 |
| Precombustion chamber module | 10 |
| First component of the module | 10a |
| Second component of the module | 10b |
| Cavity | 11 |
| Cavity longitudinal axis | 11a |
| Flange ring | 12 |
| Transfer ports | 13 |
| Openings of the transfer ports | 13a |
| Outlet openings of the transfer ports | 13b |
| Widening | 14 |
| Spanned plane of the longitudinal axes of the | 15 |
| receptacles 20, 30 | |
| Liner | 16 |
| Contact surface | 17 |
| Precombustion chamber dome | 18 |
| Screws for fixing the module to the cylinder head | 19 |
| Ignition device receptacle | 20 |
| Longitudinal axis of receptacle for ignition device | 20a |
| Spark plug | 21 |
| Guide sleeve | 22, 22a |
| Cylinder head seal | 23 |
| Receptacle for precombustion chamber injector | 30 |
| Longitudinal axis of the receptacle for the | 30a |
| precombustion chamber injector | |
| Connecting channel | 31 |
| Holding clamp | 32 |
| Precombustion chamber injector | 33 |
| Drilled holes for screws 19 | 34 |
| Screws for fixing the holding clamp to the module | 35 |
| Drilled holes for screws 35 | 36 |
| Sensor receptacle | 40 |
| Sensor | 41 |
| Valve drive | 50 |
| Exhaust valves | 51 |
| Valve bridge of the exhaust valves | 51a |
| Rocker lever of the exhaust valves | 51b |
| Drilled holes for valve lifter of the exhaust valves | 51c |
| Spanned plane of the drilled holes 51c | 51e |
| Intake valves | 53 |
| Valve bridge of the intake valves | 53a |
| Rocker lever of the intake valves | 53b |
| Drilled holes for valve lifter of the intake valves | 53c |
| Spanned plane of the drilled holes 53c | 53e |
| Valve lifter of the exhaust valves | 55a |
| Valve lifter of the intake valves | 55b |
| Cooling ribs | 60 |
| Spray pattern | 70 |

1. An internal combustion engine having a precombustion chamber, comprising:
a main combustion chamber in a cylinder of the internal combustion engine for combusting a fuel/air mixture, and
an active precombustion chamber having an ignition device protruding therein for igniting a fuel/air mixture located in the precombustion chamber and having a precombustion chamber injector that supplies fuel to the precombustion chamber, wherein at least one precombustion chamber module is provided, which is configured as a component separate from a cylinder head and is inserted into the cylinder head, and wherein the at least one precombustion chamber module comprises a cavity that forms the precombustion chamber and has at least one transfer port for fluidically connecting the precombustion chamber and main combustion chamber,
wherein
the at least one precombustion chamber module serves to functionally fix the precombustion chamber injector and/or the ignition device, and a longitudinal axis of one of components inserted into the at least one precombustion chamber module, out of the precombustion chamber injector or ignition device, extends obliquely to the longitudinal axis of the main combustion chamber.

2. The internal combustion engine according to claim 1, wherein an obliquely extending longitudinal axis of one of the components out of the precombustion chamber injector or ignition device and the longitudinal axis of the main combustion chamber form an angle which is in a range between 10° and 60°.

3. The internal combustion engine according to claim 1, wherein the longitudinal axis of one of the components out of the precombustion chamber injector or ignition device and the longitudinal axis of the main combustion chamber intersect, wherein preferably the longitudinal axis of the other component is in parallel with, preferably congruent with, the longitudinal axis of the main combustion chamber.

4. The internal combustion engine according to claim 3, wherein the longitudinal axis of the precombustion chamber injector is in parallel with, preferably congruent with, the longitudinal axis of the main combustion chamber.

5. The internal combustion engine according to claim 1, wherein the longitudinal axis of the cavity forming the precombustion chamber is congruent with the longitudinal axis of the ignition device or of a drilled hole for receiving the ignition device within the at least one precombustion chamber module.

6. The internal combustion engine according to claim 5, wherein the longitudinal axis of the precombustion chamber injector and the longitudinal axis of the drilled hole for receiving the ignition device define a plane which is located in parallel with a plane spanned by movement axes of a combustion chamber intake valve lifter and/or in parallel with a plane spanned by movement axes of a combustion chamber exhaust valve lifter.

7. The internal combustion engine according to claim 1, wherein a connecting channel is formed inside the at least one precombustion chamber module, via which connecting channel the fuel emerging from the precombustion chamber injector enters the cavity forming the precombustion chamber, wherein the connecting channel is preferably shaped, in a longitudinal direction, in such a way that the fuel entering the cavity creates an eddy therein.

8. The internal combustion engine according to claim 7, wherein an inside wall of the connecting channel has a non-cylindrical contour, preferably a conical contour, at least in portions, preferably within a continuous length portion, and preferably a remaining length region has a cylindrical contour.

9. The internal combustion engine according to claim 7, wherein the connecting channel has a curved course at least in portions, wherein a trajectory over which the curvature extends is preferably in one plane and/or the connecting channel has a helical course in the longitudinal direction, at least in portions.

10. The internal combustion engine according to claim 1, wherein the at least one precombustion chamber module is configured in one or more parts, wherein in a case of a multipart configuration sub-regions of the at least one precombustion chamber module, which are subject to high precision requirements with regard to dimensional compliance and surface quality, are preferably concentrated in a common component of the at least one precombustion chamber module, particularly preferably the cavity including the at least one transfer port and a connecting channel from the precombustion chamber injector to the cavity are configured in the common component.

11. The internal combustion engine according to claim 6, wherein the ignition device is accessible from outside, for an exchange, without removing a cylinder head cover, wherein the sub-region of the ignition device protruding out of the cylinder head is preferably located outside of a surface spanned by the movement axes of the combustion chamber intake valve lifter and the combustion chamber exhaust valve lifter.

12. The internal combustion engine according to claim 10, wherein the longitudinal axis of the cavity forming the precombustion chamber intersects with the longitudinal axis of the main combustion chamber.

13. The internal combustion engine according to claim 12, wherein a plurality of transfer ports of different port lengths are provided, and/or at least some of the plurality of transfer ports penetrate a precombustion chamber wall into the main combustion chamber not perpendicularly but rather obliquely, in order to ideally brig about turbulence of fluid guided through the plurality of transfer ports and/or of ignition torches.

14. The internal combustion engine according to claim 12, wherein outlet openings of the plurality of transfer ports facing the main combustion chamber emerge, forming a common annular group, on a dome of the at least one precombustion chamber module protruding into the main combustion chamber.

15. The internal combustion engine according to claim 1, wherein the ignition device is introduced into the internal combustion engine from an air intake side of the cylinder head.

16. The internal combustion engine according to claim 8, wherein a seat ring is arranged between the at least one precombustion chamber module in a region of the at least one transfer port and a contact surface of the at least one precombustion chamber module on the cylinder head, in particular in a region of a flame plate.

17. The internal combustion engine according to claim 7, wherein the cavity forming the precombustion chamber does not have a rotationally symmetrical geometry, wherein a volume-enlarging partial widening of the cavity is provided.

18. The internal combustion engine according to claim 1, wherein the precombustion chamber injector is attached to the at least one precombustion chamber module by means of a holding clamp, wherein the holding clamp is detachably screwed to the at least one precombustion chamber module.

19. The internal combustion engine according to claim 1, wherein the at least one precombustion chamber module comprises at least one sensor receptacle into which a sensor can be introduced for detecting at least one state value inside the precombustion chamber, wherein the sensor is preferably suitable for pressure and/or temperature measurement, and/or for measuring a lambda value inside the precombustion chamber.

20. The internal combustion engine according to claim 1, wherein one or more cooling channels that guide a coolant are formed in the cylinder head in such a way, as a result of which a cooling medium flowing therein flows around an outside wall of the at least one precombustion chamber module, in particular a wall region of the at least one precombustion chamber module that surrounds the cavity.

21. The internal combustion engine according to claim 20, wherein one or more ribs are formed on the outside wall of the at least one precombustion chamber module, in a region of surrounding cooling channels.

22. The internal combustion engine according to claim 10, wherein the internal combustion engine can be operated with an operating mode according to which the active precombustion chamber serves exclusively as an ignition amplifier, and/or direct injection of fuel into the main combustion chamber via the active precombustion chamber takes place, and/or there is at least one alternative fuel supply path into the main combustion chamber, for example an intake manifold injection, and the fuel can be injected into the main combustion chamber selectively via the precombustion chamber and/or the at least one alternative fuel supply path, ideally depending on a current engine load.

23. The internal combustion engine according to claim 22, wherein the internal combustion engine is configured, in the case of a possible fuel supply via the active precombustion chamber and at least one alternative fuel supply path into the main combustion chamber, for example via the intake manifold injection, to additionally carry out its original precombustion chamber function of pre-injections and/or subsequent injections, via the active precombustion chamber.

24. The internal combustion engine according to claim 22, wherein the internal combustion engine, the active precombustion chamber of which serves exclusively as an ignition amplifier, comprises at least two separate fuel reservoirs, in order to be able to supply different fuels to the active precombustion chamber and the main combustion chamber.
